(19) United States
(12) Patent Application Publication
(10) Pub. No.: US 2010/0176762 A1
(43) Pub. Date: Jul. 15, 2010

(54) Vertical Charging Apparatus

(76) Inventors: E. Andrew Daymude, Valencia, CA (US); Susan S. Daymude, Valencia, CA (US)

Correspondence Address: Cislo & Thomas LLP, 1333 2nd Street, Suite #500, Santa Monica, CA, 90401-4110, US

(21) Appl. No.: 12/687,058

(22) Filed: Jan. 13, 2010

Related U.S. Application Data
(60) Provisional application No. 61/204,938, filed on Jan. 13, 2009.

(51) Int. Cl. H02J 7/00

(52) U.S. Cl. 320/115; 320/110

(57) ABSTRACT

An apparatus for storing and charging a plurality of devices. The apparatus includes a plurality of holders and a power source. The holders may be vertically aligned. The power source can be connected to a standard outlet or, for portability, a battery pack or solar panel. The apparatus also includes a support member coupled to the power source to support the holders. For each holder within the plurality of holders, a universal outlet capable of charging an electronic device may be provided. Each universal outlet can be coupled with a connector providing the appropriate power to the electrical device placed on the holder. Otherwise, the apparatus may maintain connectors within the power source and routed through wire molded slots to each holder to provide the appropriate power to the electrical device placed on the holder.

### CROSS-REFERENCE

This patent application claims the benefit of U.S. Provisional Patent Application Ser. No. 61/204,938, entitled “Vertical Electronic Charging Apparatus,” filed Jan. 13, 2009, which application is incorporated in its entirety here by this reference.

### TECHNICAL FIELD

This application generally relates to a charger, and, more particularly, a charger that can charge multiple devices through a multi-tiered apparatus having a plurality of holders.

### BACKGROUND

To improve portability and versatility, electronic devices, such as iPods, laptop computers, gaming consoles and controllers, mobile/cellular/smart phones, personal digital assistants, and the like, utilize rechargeable batteries. These electronic devices typically come with their own specific charging cord and must be charged regularly. However, there are generally not enough plugs or receptacles for these devices at a single household location. In addition, the distance between the actual receptacles in a typical plug or power strip is too close for charging multiple devices at the same time.

Because each of these devices requires different connectors, linking the devices to the appropriate connector or charger can be difficult and frustrating often involving manipulating tangled wires. Large amounts of time can be consumed trying to find the right connector for the right device. In addition, the overall appearance of the area where mobile phones and other devices are charging is messy and disorganized due to the lack of wire management.

### SUMMARY

This summary is provided to introduce a selection of concepts in a simplified form that are further described below in the DESCRIPTION OF THE INVENTION. This summary is not intended to identify key features of the claimed subject matter, nor is it intended to be used as an aid in determining the scope of the claimed subject matter.

In accordance with one aspect of the present application, an apparatus is presented. The apparatus includes a central power source and a set of universal sockets coupled to the central power source. In addition, the apparatus includes a plurality of holders distributed in a vertical manner. Each holder within the plurality of holders maintains a universal socket within the set of sockets for charging electronic devices.

In accordance with another aspect of the present application, an appliance for charging a number of electrical apparatuses simultaneously is presented. The appliance includes a housing containing a power source and a support member coupled to the housing. In addition, the appliance may include a plurality of holders evenly spaced that are stacked one on top of each other and attached to the support member. Each holder maintains a socket for the electrical devices.

In accordance with yet another aspect of the present application, a charger is presented. The charger includes a set of holders vertically placed above a horizontal plane and a plurality of universal plugs corresponding to each holder within the set of holders. In addition, the charger includes a connector for each universal plug for distributing power to the devices.

### BRIEF DESCRIPTION OF DRAWINGS

FIG. 1 is a front elevation view of an embodiment of a vertical electronic charging apparatus in accordance with an aspect of the present application;

FIG. 2 is a front elevation view of another embodiment of the present application;

FIG. 3A is a front perspective view of another embodiment of the present invention in a closed configuration;

FIG. 3B is a front perspective view of the embodiment shown in FIG. 3A in the open configuration with sample electronic devices;

FIG. 3C is a rear perspective view of the embodiment shown in FIG. 3B in the open configuration;

FIG. 3D is a side elevation view of the embodiment shown in FIG. 3B with the door in the open configuration;

FIG. 4 is a close up of the section labeled as 4 in FIG. 3B with a portion of the tray removed to show the cavity;

FIG. 5 is a front perspective view of another embodiment of the present invention;

FIG. 6 is a front perspective view of another embodiment of the present invention;

FIG. 7 is a front perspective view of another embodiment of the present invention;

FIG. 8A is a front view of another embodiment of the present invention in an open configuration; and

FIG. 8B is a front view of the embodiment shown in FIG. 8A in the closed configuration.

### DESCRIPTION OF THE INVENTION

The description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Generally described, the present application is directed towards a charging station 100 or a charging stand. More specifically, the present application relates to a plurality of holders 108 that are vertically or horizontally aligned, each holder providing access to a power source for charging an electronic device 10 held by the holder 108. By way of example only, electronic devices 10 that may be stored and charged by the apparatus include, but are not limited to, cellular, mobile, and smart phones and their accessories, such as a BlackBerry, iPhone, and Bluetooth earpieces, iPods, personal digital assistants, video and digital cameras, notebooks, laptops, netbooks, e-Readers, electronic tablets, gaming controllers and consoles, and other electronic devices that need to be recharged on a regular basis. Furthermore, in some embodiments, non-electronic devices can be placed on or within the apparatus such as wallets, keys, purses, bags, clothing, and the like. For non-electronic devices, hooks, pegs, trays, and the like may be utilized.

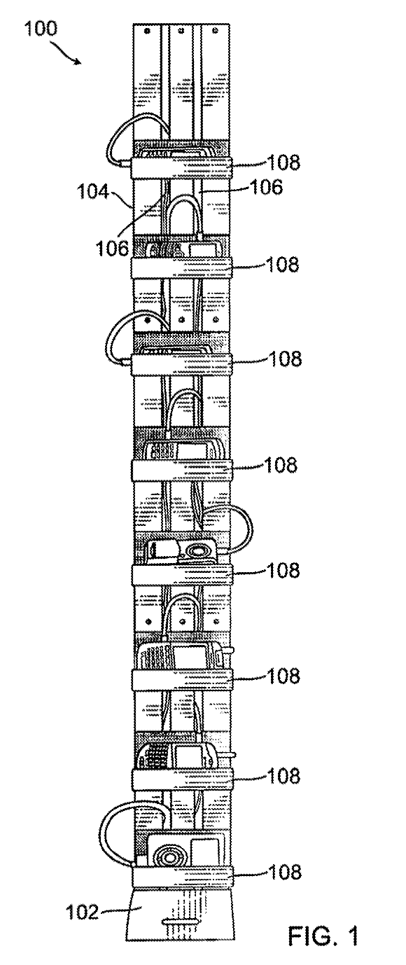

As shown in FIG. 1, the charging station 100 comprises a support member 104. The support member 104 provides the basic framework of the charging stand 100. In the preferred embodiment, the support member 104 has an elongated box-like shape defining a vertical axis A and having a front side 200, a back side 210 opposite the front side 200, a first side 202 adjacent to the front side 200 and the back side 210, a second side 204 opposite the first side 202 and adjacent to front side 200 and the back side 210, a top 206 adjacent to the front side 200, the back side 210, the first side 202, and the second side 204, and a bottom 208 opposite the top 206 and adjacent to the front side 200, the back side 210, the first side 202, and the second side 204, thereby defining a compartment 300. The power cord 302 and associated wires for the chargers may be housed inside the compartment 300. Attached to the front side 200 are holders 108 to hold the electronic devices.

In addition, support member 104 may have wire molded slots 106 on the interior side for routing charging wires to each of the holders. While FIG. 1 depicts two exposed slots 106, one skilled in the relevant art will appreciate that these slots 106 may come in a variety of forms including a single slot 106. The slots 106 may be capable of being concealed. Slots 106 may also be placed in the back or sides of apparatus 100. The support member 104 can also include a power source 102, such as a power strip, an extension cord, a power squid, a track light system with adjustable track plugs, a wired mold, a call pod with five-Mini-USB plug ends, and the like.

The support member 104 may comprise a means for containing non-electronic items or other items that may not require charging. A variety of means for containing these non-charging items can be utilized. For example, the top 206 of the charging station 100 may comprise a concavity 306 or a dish 308 may be molded into the top surface 206. The concavity 306 or dish 308 may be used to contain electrical or non-electrical items such as money, wallets, keys, and the like. In some embodiments, the top 206 may be a flat surface or a recessed surface. In some embodiments, the top 206 may further comprise a lid 500 to conceal the contents on the top surface 206. The lid 500 may be adorned with a variety of decorative material or may comprise functional items 502 such as a clock, radio, thermometer, and the like.

In some embodiments, the support member 104 may also include drawers 600 into which the non-electronic or non-charging items may be kept. In addition, hooks, pegs, and other protuberances may be provided on the top, sides, front, or even from the back for hanging keys, bags, purses, clothes, and the like.

A door 212 may be attached to one of the sides 202, 204, the back 210, or the front 200 of the charging station 100. In the preferred embodiment, the door 212 is attached to one of the sides 202, 204 of the charging station 100. The door edge 214 may be chamfered to facilitate opening the door 212. Alternatively, a handle may be attached to the door 212 to facilitate opening the door 212. The interior compartment 300 may be accessed through the door 212 to insert and arrange the cords 302.

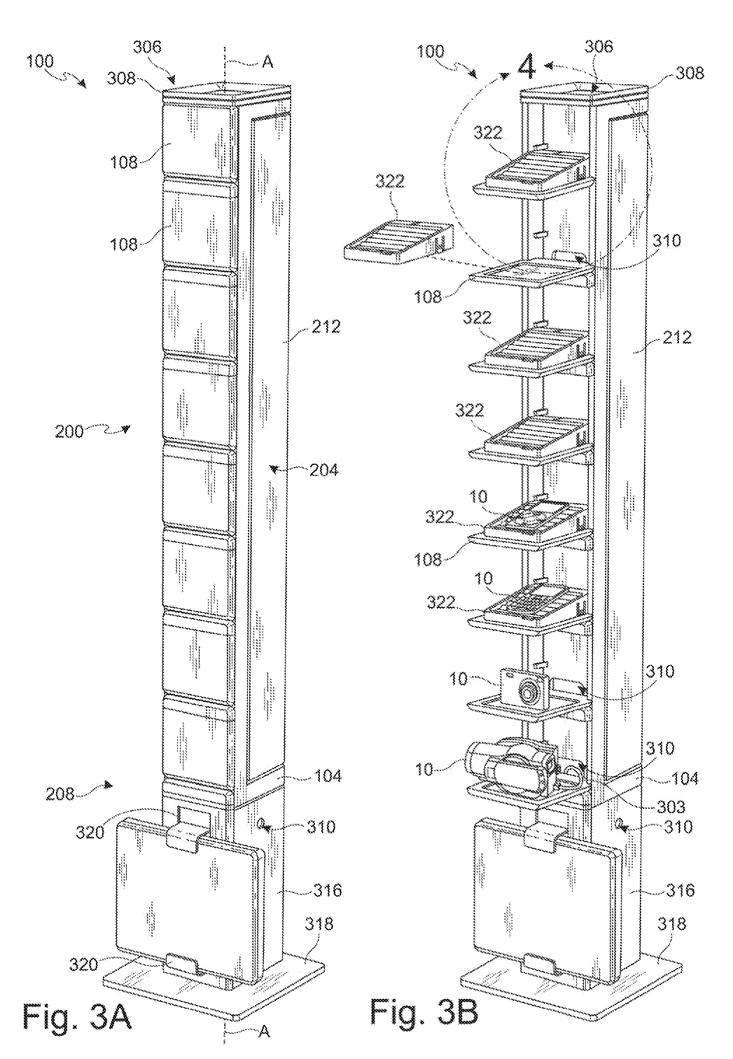

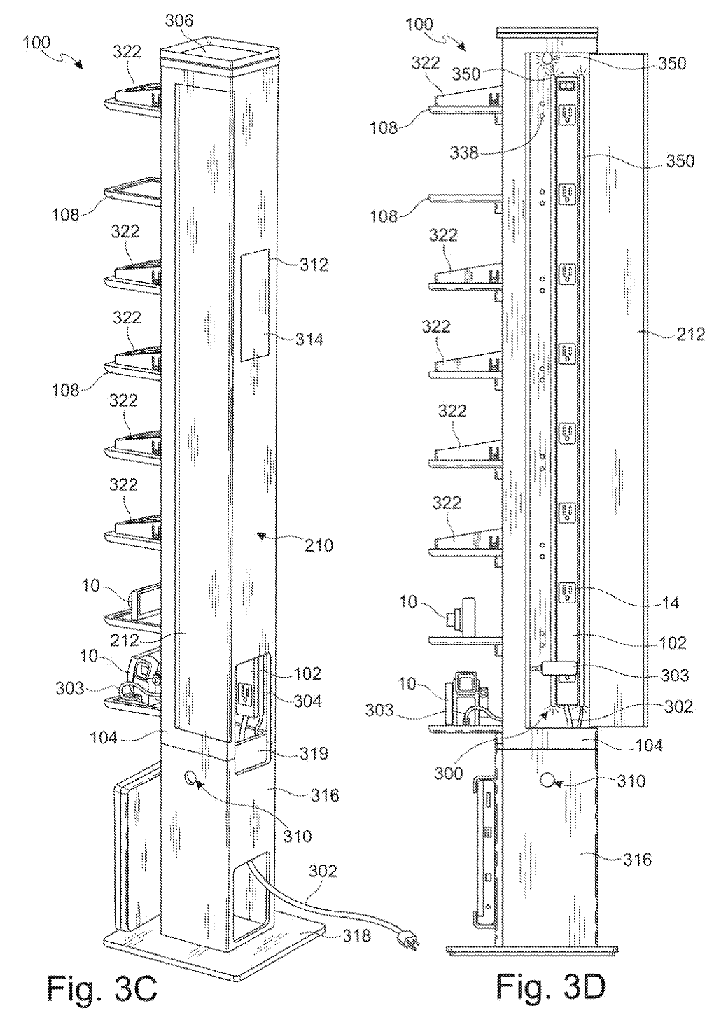

The front side 200 comprises a plurality of openings 310 through which charging cords 303 may be introduced to the holders 108. The front openings 310 are sized large enough for the charging cords to pass through. The holders 108 may be hingedly attached to the front side 200 so that the holder 108 is rotatable from a closed configuration in which the holder 108 covers the front opening 310 to an open configuration as shown in FIGS. 3A and 3B. Openings 310 may also be created on one or both of the sides 202, 204 to allow charging cords 303 to exit from the compartment through the sides.

The back 210 of the charging station 100 may also comprise at least one opening or cut-out 312 through which the power cord 302 can exit and plug into a receptacle in the wall. Additional cut-outs 312 may be created to accommodate multiple power cords 302 positioned at different levels inside the charging station 100.

In addition, the back 210 of the support member 104 can be configured to be mounted on the wall. For example, the back may have a cut-out 312, a hook, a lip or any other device or formation so as to be mounted on the wall with nails, hooks, or other fasteners. In the embodiment with a cutout 312, a removable plate 314 may be provided to cover the cut-out 312 when the support member 104 is not mounted on the wall.

In some embodiments, a detachable base 316 connectable to the bottom 208 of the support member may be used to provide a foundation for the charging station 100. The base 316 may further comprise a foundation plate 318 to reduce the swaying of the support member 104. The base 316 and the support member 104 may have a male/female connection 319 configuration to easily connect and disconnect the base 316 from the support member 104. Thus, the support member 104 may be easily slid onto the base 316. A fastener can be provided to lock the base 316 to the support member 104. The base 316 or the support member 104 may have a series of positional stops to adjust the height of the support member 104. In the wall mount configuration the base 316 would not be required.

The detachable base 316 may further comprise a clamp 320 to hold large electronic devices 10, in other words, devices that are too large to fit on the holders 108. The clamp 320 may be vertically and horizontally adjustable to accommodate large electronic devices 10 of different sizes. For example, the clamps 320 may be spring-loaded so as to clamp onto an electronic device 10, such as a laptop computer.

The detachable base 316 may also contain openings 312, such as cut-outs, slots, grommets, and the like, for the passage of power cords 302. The openings 312 for the power cord may be positioned on the back 210 to keep the cord hidden. The openings 310 for the charging cords may be positioned on the sides 202, 204 or the front 200 for ease of connection to the electronic device 10.

Typically, the support member 104 and base 316 can be made of peg board or strong wood that can hold a variety of devices. Alternatively, support member 104 can be made of molded plastic, metal, or any other sturdy material.

Coupled to support member 104 is a plurality of holders 108 for securing an item while being charged. The holders 108 may be in the form of a cradle, pocket, shelf, drawer, hooks, clamps, or the like, and therefore, come in a variety of forms including flat surfaces, cubes, cups, boxes, drawers, protuberances, and the like, or any combination thereof. For example, each holder 108 coupled to the support member 104 can be of a different shape, style, or form from the other holders coupled to support member 104.

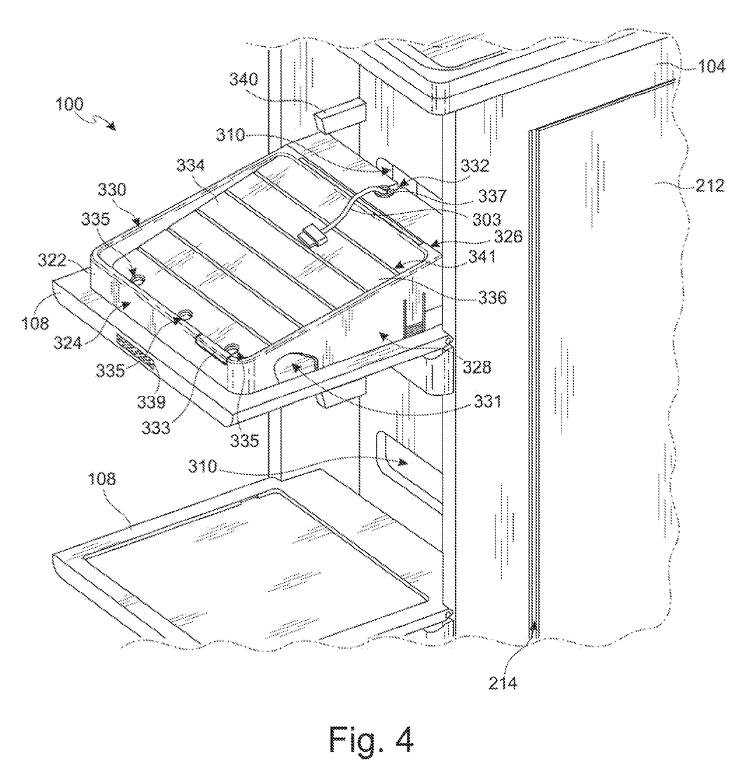

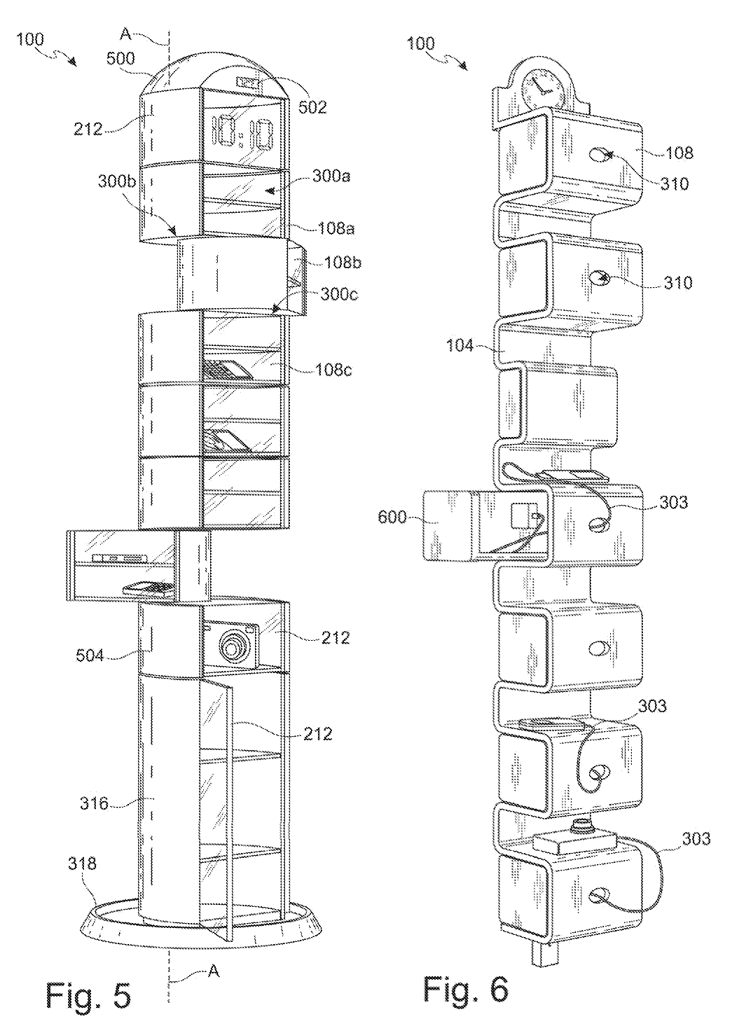

In embodiments in which the holder 108 can conceal an item, such as the drawer embodiment, the electronic device 10 may be placed inside the drawer as shown in FIG. 5. Alternatively, the electronic device 10 may be placed outside the drawer and the power receptacle may be hidden inside the drawer as shown in FIG. 6.

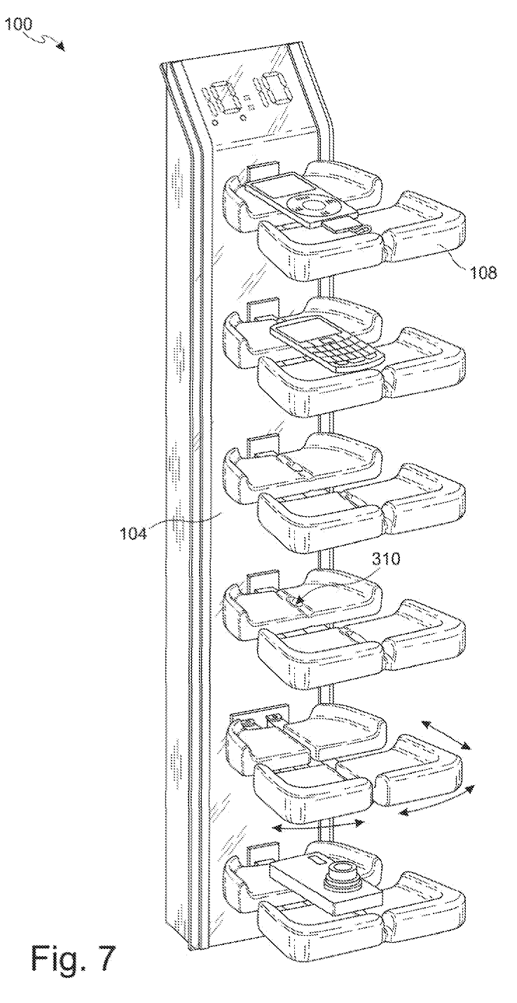

In some embodiments, the holders 108 can be fitted so that they conform to the shape of a particular device. For example, a holder 108 can specifically fit an iPhone/iTouch/iPod. In some embodiments, the holder 108 itself may be adjustable to accommodate electronic devices of different sizes. For example, the holder 108 may be expandable in the lateral direction to increase the width of the holder and/or expandable in the forward-backward direction to increase the depth of the holder as shown in FIG. 7. Various means for expanding the holder 108 may be utilized as is known in the art. For example, the holder may be constructed of various individual pieces mounted on support bars that are rotatably and/or slidably engaged with each other.

Typically, the charging station 100 has more than one holder 108. In a preferred embodiment, the charging stand has a set of holders. The holders 108 may be vertically aligned, one on top of the other, although a horizontal arrangement may also be used. The plurality of holders 108 provides a stable and secure location to rest electronic devices 10. Furthermore, the plurality of holders 108 allow for multiple devices 10 to be charged simultaneously while preventing the devices from falling or slipping onto the floor. Essentially, the charging station 100 provides an actual physical location to set up a charging area where all electronic devices 10 can be conveniently located and centralized. The charger 100 also removes the cumbersome issue of plugging in the electronic devices 10 behind furniture or other hard-to-reach areas.

While the holders 108 may be evenly spaced and vertically aligned, the holders 108 may also come in a variety of other configurations. For example, holders 108 can be positioned on alternating sides. Furthermore, holders 108 can be on all sides of support member 104 and are not limited to the front side 200.

To further improve the versatility of the configuration, the holders 108 may be adjustable along or about the support member 104. The holders 108 may be adjustable along the support member 104 to allow for customized spacing in between holders 108. A variety of means for adjusting holder spacing is known by those skilled in the art, such as providing a plurality of holes or slots along the support member with removable pegs or hooks upon which the holders 108 are seated. Therefore, if a large electronic device 10 requires charging, then a holder 108 may be removed or adjusted allowing enough room for that electronic device 10 to be placed on the holder 108. Conversely, if an electronic device 10 requires little room, then the holders 108 may be adjusted as such. In some embodiments, the holders 108 may be fixed or even integrally formed with the support member as shown in FIG. 7.

In the preferred embodiment, the plurality of holders 108 are hingedly mounted to the front side 200 of the support member 104. The holders 108 can rotate from a closed position to an open position as shown in FIGS. 3A and 3B. A peg 340 may be positioned towards the back of the holder in the open position to prevent the holder from over-extending. In the closed position, the charging station 100 has the appearance of an elongated box that adds to the aesthetic nature of the charging station. In the preferred embodiment, the support member 104 is configured so that the holders 108 are arranged in a vertically aligned manner. This provides a compact and efficient use of space with an aesthetically pleasing appearance. However, the support member 104 may also be configured so that the holders 108 are arranged horizontally or in any other orientation.

In some embodiments, the holders 108 may be rotatably connected to the support member 104 at a peripheral edge 504 so as to allow the holders 108 to rotate about the vertical axis A defined by the support member 104 as shown in FIG. 5. This provides another means for concealing and revealing the contents of the holder 108 having a compartment 300, such as the drawer embodiment. For example, when all of the holders 108 are vertically aligned, then one holder 108a conceals the contents of a lower holder 108b immediately below the first holder 108a. When the lower holder 108b is rotated about the vertical axis A, either in a clockwise or counter-clockwise direction to misalign the lower holder 108b from the holder above and below it 108a, 108c, its compartment 300b and the compartment of the holder immediately below it 300c are exposed.

In some embodiments, the holders 108 may further comprise a removable tray 322. The removable tray 322 may have a wedge-shaped body comprising a front side 324, a back side 326 opposite the front side 324, and two sides 328, 330 opposite each other and adjacent to the front 324 and back 326 sides, the front 324, back 326 and two sides 328, 330 defining a cavity 331, wherein the two sides 328, 330 taper from the back side 326 toward the front side 324, and wherein the back side 326 comprises a cord slot 332 configured to receive a charging cord 303.

A mat 334 may be hingedly attached to the back side 326 of the wedge-shaped body to cover the cavity, the mat 334 comprising a second cord slot 332 configured to receive the charging cord. Since the mat 334 is hingedly connected to the back side 326 of the tray 322 and the back side 326 of the tray 322 is higher than the front side 324 of the tray 322, the mat 334 is angled or sloped downwardly as the mat 334 moves away from the support member 104. This allows any device placed on the mat 334 to be more easily visible. This is particularly relevant for flat devices such as cell phones, mobile phones, smart phones, MP3 players, PDA's and the like. A release button 333 allows the mat to open thereby exposing the cavity 331 to feed the charging cord 303 through the opening 335 in the mat 334.

In some embodiments, the mat 334 may have a plurality of openings 335 for multiple charging wires. This allows the charging wire to protrude either from the back of the holder 108 or from the front portion of the holder 108. For example, some electronic devices 10 such as cell phones, smart phones, PDAs, and iPods have charging sockets located at the bottom of the device. Having the charging cord 303 protrude from the front of the holder 108 allows the device to be connected to the charging cord 303 while maintaining an upright configuration. In either case most of the charging cords 303 remain hidden underneath the mat 334 and/or behind the holder 108, thereby providing an aesthetically pleasing appearance. In addition, having a plurality of openings 335 accommodates devices having charging docks on any side of the device. Thus, whether the device is charged from the top, left, right, or bottom, the same holder can provide the proper positioning of the charging cord.

The mat 334 may be constructed of any type of material that provides a non-abrasive, non-slip surface that provides some traction and shock-absorption to prevent damage to the electronic device 10 and reduce the possibility of the electronic device 10 slipping off the holder 108. For example, each holder 108 can be made of or wrapped with rubberized material for non-skid as well as anti-scratch material. In some embodiments, the mat 334 may have protuberances 336 and/or grooves 341 to improve traction.

To further improve security of the electronic devices 10, the holders 108 may also have fasteners, such as hook and loop fasteners, elastic bands, clips, clamps, or the like, to secure the items onto the holders 108. Alternatively, holders 108 may contain some other type of clasping mechanism to secure the items. One skilled in the relevant art will appreciate that holders 108 may contain numerous types of means of securing items to the holders.

In some embodiments, identification labels 339 may be placed on each holder 108 or tray 322 for identification of the device owner or device name.

The power source 102 provides power to the electronic devices 10 stored on the charging station 100. As such, the charging station 100 generally provides a compartment 300 where the charging cords 303 for a plurality of devices can be centralized. The power source 102 can be attached or detached from apparatus 100. The power source 102 can also be coupled to a socket or a battery pack for portability. Furthermore, power source 102 can be a solar panel located on the top or sides to power the charging station with an alternative energy source or some other similar type of green initiative apparatus.

In the preferred embodiment, to preserve the aesthetic and orderly appearance of the charging station, the power source 102 may be hidden in the support member 104. In some embodiments, the power source 102 may be coupled to the bottom 208 or the base 316 of charging apparatus 100. While the power source 102, as shown in FIG. 1, is coupled to the bottom of apparatus 100, power source 102 may be attached at any location on or inside the apparatus 100 including at the middle, top, or sides. In addition, the power source does not need to be in a centralized location, but can be distributed throughout apparatus 100.

As provided in FIG. 1, the power source 102 may be an integral portion of the base of apparatus 100. The power source 102 can provide a sturdy base on which apparatus 100 sits on. The power source 102 can maintain a certain weight for providing stability to apparatus 100. Furthermore, the power source 102 can have a relatively flat but wide cross sectional area for providing stability. One skilled in the relevant art will appreciate that the power source 102 may come in a variety of shapes and sizes to provide support for apparatus 100.

Alternatively, the power source 102 does not have to provide support for the charging station 100. The charging station 100 can be supported on its own base. In some embodiments, attachment means are provided to secure the charging station to a wall or other solid fixture. Furthermore, the charging station 100 can be sturdy enough to provide its own support for itself and any additional weight brought on by the devices.

In some embodiments, the power source 102 can have prefabricated UL listed, 110 volt power regular household current. The individual power source 102 can have a minimum of 3 inches of spacing between each receptacle 14 so that chargers will fit without wasting outlets.

In some embodiments, each holder 108 may include its own universal plug. To charge a specific device, a charger is coupled to the universal plug for each holder 108 and attached to the device. In some embodiments, the power source 102 may be a power strip attached to the charging station inside the compartment 300 and charging cords for individual devices may be connected to the power strip and connected to a specific holder 108 or holder available for easy connection to the electronic device. The holder 108 may comprise an opening through which the charging cord may be inserted.

In the preferred embodiment, the opening is a slot 332 having a rubber or plastic insert 337. The insert 337 may also be a slot having a smaller opening. This allows the charging cord to be easily inserted into the insert 337, but the insert 337 may provide resistance to prevent the charging cord from slipping out. In some embodiments, a grommet may be supplied to place around the charging cord to prevent the charging cord from slipping out from the slot.

The charging station 100 further comprises a wire management scheme to manage the charging cords in an orderly and efficient manner. In some embodiments, a universal socket for each holder 108 on apparatus 100 is provided. Beginning from the bottom of apparatus 100, several wires are placed within power source 102. Each of these wires is then routed through support member 104 along wire molded slots 106. Each wire ends at a universal socket located on each holder 108. The universal socket allows for multiple types of connectors for a plurality of electronic devices for that holder 108 to be easily connected and removed. For example, an iPod can be charged through coupling an associated connector into the universal plug located on holder 108 with the iPod. This removes the need for rewiring the multiple holders. In addition, the connectors can be truncated to remove excess wiring. Power cords, chargers, and devices are readily removable without disturbing the other devices or chargers thus removing clutter.

In some embodiments, a power strip with long and wide receptacles 14 can be placed within support member 104. From there, the individual charging cords for the electronic devices can be routed through wire molded slots 106. As a result, charging cords for each electronic device would be located on the holders 108. Each time the user wishes to alter the configuration of apparatus 100, each of the connectors for the plurality of devices would have to be rerouted through the wire molded slots 106. This may require removing and reconnecting holders 108.

In some embodiments, rather than routing charging cords through molded slots, each holder may have at least one protuberance 338 associated with it about which the charging cords can be wrapped. This will provide just enough cord length to reach the holder 108 while managing the excess cord. The protuberances 338 may be integrally formed or attached to the support member 104 adjacent to their respective holders 108.

This wire management scheme typically holsters quickly and neatly up to 6 feet of 18 inch gauge charger wires. The wire management scheme generally holds charger plug-in ends stationary for the last few inches of wire so it does not fall away, can be easily reconnected, and cannot be mistakenly connected at the next charger. This makes it easy for disconnection and reconnection for travel. Furthermore, the apparatus 100 using this wire management scheme looks great and is easy-to-use while easy-to-build and thus provides a marketable product.

In some embodiments, each device end of the AC charger has a grommet or twist tie top hold end so that the charger is prevented from falling back into the housing thereby reducing connection frustration. Alternatively, protuberance 338, such as a post type cable organizer can be provided to wind excess cable between each charger end and the AC plug to the device.

For each of the schemes presented above, apparatus 100 can provide a convenient way for prioritizing and charging electronic devices. For example, apparatus 100 having several holders 108 and positioned on the floor can secure and charge devices that require charging everyday near the top. While devices that require charging less are near the bottom of apparatus 100. Essentially, the more often a device requires charging, the higher the device would be placed on a holder 108 of apparatus 100.

On the other hand, when apparatus 100 is mounted on a wall or higher location and it would be easier to reach the bottom or mid-section of apparatus 100, electronic device requiring frequent charging would be placed near the bottom. Alternatively, electronic devices requiring less charging would be placed on the top of apparatus 100.

While several wire management schemes have been provided, one skilled in the relevant art will appreciate that there are numerous ways to provide power to the electronic devices placed on holders 108. Each of the schemes presented above are intended as exemplary configurations and thus, should not be construed as limiting to the scope of this application.

In some embodiments, some sockets can be turned off in order to prevent shorting the circuit. In addition, apparatus 100 may also include a surge protector for any power surges that may occur. The apparatus 100 can also account for the electrical differences provided by each country.

While each holder 108 for apparatus 100 may be used was for a single electronic device, a single holder 108 may also hold and charge multiple items. Generally, these items would be related. For example, holder 108 could hold both a Bluetooth head set along with a mobile phone. Furthermore, some holders 108 can contain electronic devices that require consistent power like televisions, alarm clocks, radios, etc.

While exemplary components have been described, one skilled in the relevant art will appreciate that apparatus 100 may include additional components and those components described above are not limiting. Furthermore, multiple wire management schemes exist for connecting the power source to the electronic devices placed on the holders 108 as provided below. Through these wire management schemes, charging multiple electronic devices is simple and as compact as possible.

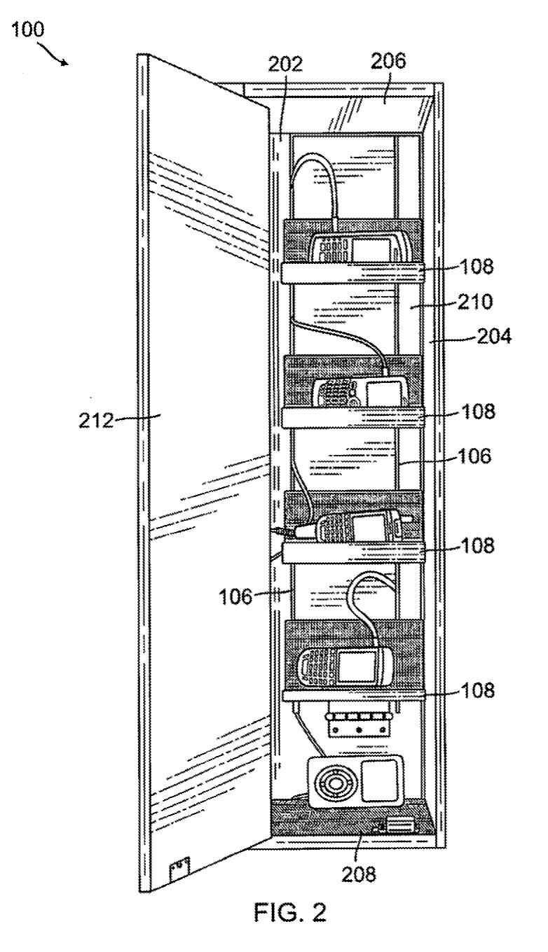

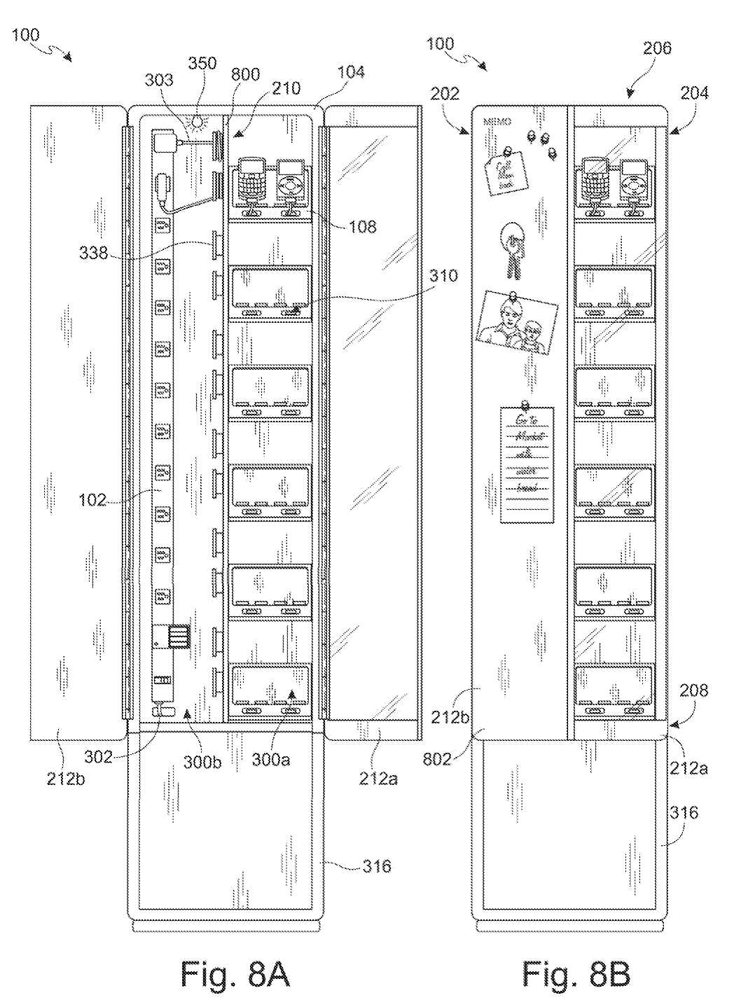

FIGS. 2 and 8A-8B depict another illustration showing alternative embodiments of the vertical electronic charging apparatus 100 in accordance with one aspect of the present application. In these embodiments, apparatus 100 is shaped like a box or cabinet having a left side 202, right side 204, top side 206, bottom side 208, a back side 210, and an optional door panel 212. Holders 108 can be supported by the left side 202 and right side 204. Furthermore, holders 108 can typically be secured to the back side 210. Apparatus 100 can be locked by closing optional door panel 212 to the formed box or cabinet.

In some embodiments, a dividing wall 800 may be placed inside the cabinet to create two separated compartments 300a, 300b to separate the electronic devices from the power supply as shown in FIG. 8A. In the first compartment 300a, the holders 108 may be connected to the one of the side walls 202, 204, the dividing wall 800 and the back wall 210. An opening 310 may be created in the dividing wall 800 for insertion of the charging cord 303. On one side of the dividing wall 800, protuberances 338 may be attached to manage the charging cord 303. The power supply, such as a power strip may be contained in the second compartment 300b.

The two compartments 300a, 300b may have separate doors 212a, 212b to conceal the contents of the compartments 300a, 300b. At least one of the doors 212a or 212b may comprise a means for posting messages 802 such as a cork board, a dry erase board, a magnetic board, and the like, or any combination thereof. In some embodiments, the door 212a to the electronic devices 10 may be transparent or semi-transparent so that the electronic devices 10 are visible.

In some embodiments, apparatus 100 can have a false back 210 to create a rear compartment to house the power supply, adapters, and cord management area to keep them out of sight. The cabinet can also have side and top venting slots for reducing heat generated by the charging devices.

The cabinet can be free standing, vertically wall mounted, or horizontally wall mounted to save desk or unused wall space. The apparatus 100 may be removable or mounted on a wall using conventional wall anchors and screws, and/or any type of brackets or brace utilizing mounting holes provided in back 210 of the cabinet.

In other embodiments, when the cabinet door 212 is opened, an internal light 350 can illuminate the inside for seeing devices and plugs making it easier to connect the power to the devices. The internal light can be a single or multiple light bulbs, or a strip of lighting. The cabinet can be available in a variety of decorative finishes intended to match furnishing of fixtures or décor within the area of intent of use.

Also, a long power cord, for example having a length of at least approximately 6 feet can be stored within the cabinet making an extension cord unnecessary. This power cord can be retractable or wound around the protuberance 338 allowing less clutter around the apparatus 100.

In some embodiments, the apparatus 100 may also be modular. For example, one module comprising at least one holder 108 attached to a support member 104 may be connectable to a second module comprising at least one holder 108 attached to another support member 104 so that the user can configure the size of the apparatus 100 as he or she chooses. Each module may be connectable in a stackable fashion so the apparatus 100 can grow vertically, or in a horizontal or side-by-side fashion so the apparatus 100 can grow horizontally, or both. Thus, each module may be configured at the terminal ends or the connection ends to allow the modules to easily and securely connect to each other. For example, the terminal or connection ends may comprise a tongue and groove configuration, male/female connection configuration, peg and socket, adapters, and the like.

Since the holder 108 can take on a variety of styles, such as shelves, hooks, clamps, drawers, and the like, the user can configure the apparatus 100 by arranging the modules with the different styles of holders 108 in any order. As one example, a module like the base 316 with the clamp 320 shown in FIGS. 3A-3B may be inserted in between two other modules having shelves, thereby bringing the large electronic device to a higher level to secure and access more easily.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A charging apparatus, comprising:
a. a support member, comprising:
i. a front side,
ii. a back side opposite the front side,
iii. a first side adjacent to the front side and the back side,
iv. a second opposite the first side and adjacent to front side and the back side,
v. a top adjacent to the front side, the back side, the first side, and the second side, and
vi. a bottom opposite the top and adjacent to the front side, the back side, the first side, and the second side,
vii. the front side, back side, first side, second side, top and bottom defining a compartment, wherein the top comprises a concavity, wherein the first side comprises a door, and wherein the back side comprises a first opening for the passage of a power cord;
b. a power source housed inside the compartment, the power source, comprising a plurality of sockets;
c. a wire management system inside the compartment;
d. a plurality of holders distributed in a vertical manner along the support member, wherein each holder is hingedly connected to the front side of the support member to adopt an open configuration and a closed configuration;
e. at least one tray removably mountable on a first holder, the at least one tray comprising,
i. a wedge-shaped body comprising a front side, a back side opposite the front side, and two sides opposite each other and adjacent to the front and back sides, the front, back and two sides defining a cavity, wherein the two sides taper from the back side toward the front side, and wherein the back side comprises a first cord slot configured to receive a charging cord, and
f. a mat hingedly attached to the back side of the wedge-shaped body to cover the cavity, the mat comprising a second cord slot configured to receive the charging cord; and
g. a detachable base connectable to the bottom of the support member, the detachable base comprising:
i. a clamp to hold large electronic devices, wherein the clamp is vertically and horizontally adjustable to accommodate large electronic devices of different sizes,
ii. a foundation plate to provide support for the detachable base,
iii. a second opening for the passage of the power cord, and
iv. a third cord slot.

2. A charging station, comprising:
a. a support member defining an axis;
b. a plurality of holders moveably attached to the support member, the plurality of holders configurable from a closed position to an open position;
c. a power source housed inside the support member; and
d. a wire management system housed inside the support member.

3. The charging station of claim 2, wherein the plurality of holders are distributed in a vertical manner along the support member.

4. The charging station of claim 3, wherein each holder comprises a wall, thereby defining a cavity.

5. The charging station of claim 4, wherein each holder is rotatably attached to the support member at a peripheral end such that each holder can swivel about the axis, wherein when a first holder is aligned with a second holder, the compartment of the first holder is concealed and wherein when the first holder is misaligned relative to the second holder the compartment of the first holder is revealed.

6. The charging station of claim 2, further comprising at least one tray removably mountable on the holder, the at least one tray comprising a wedge-shaped body comprising a front side, a back side opposite the front side, and two sides opposite each other and adjacent to the front and back sides, the front, back and two sides defining a cavity, wherein the two sides taper from the back side toward the front side, and wherein the back side comprises a first cord slot configured to receive a charging cord.

7. The charging station of claim 6, further comprising a mat hingedly attached to the back side of the wedge-shaped body to cover the cavity, the mat comprising a second cord slot configured to receive the charging cord.

8. The charging station of claim 7, wherein the mat comprises a non-skid, shock absorbent surface.

9. The charging station of claim 2, wherein a dimension of the holder is adjustable to accommodate devices of different sizes.

10. The charging station of claim 2, further comprising a door to conceal the plurality of holders.

11. The charging station of claim 10, wherein the door comprises a means for posting messages.

12. The charging station of claim 2, further comprising a removable base for floor mounting.

13. The charging station of claim 2, wherein each holder comprises a power outlet.

14. The charging station of claim 2, wherein the support member comprises a concave top to hold non-electronic items.

15. The charging station of claim 2, further comprising an adjustable clamp to hold electronic devices having dimensions greater than the holder.

16. A charger, comprising:
a. a plurality of holders vertically aligned along a vertical axis;
b. a plurality of universal plugs corresponding to each holder within the plurality of holders; and
c. a connector for each universal plug for distributing power to the devices.

17. The charger of claim 16, wherein at least one holder, comprises:
a. a tray removably mountable on the holder, the at least one tray comprising a wedge-shaped body defining a cavity, wherein the tray comprises a first cord slot configured to receive a charging cord; and
b. a mat hingedly attached to the wedge-shaped body to cover the cavity, the mat comprising a second cord slot configured to receive the charging cord.

18. The charger of claim 17, wherein the plurality of holders are moveably mounted on a support member and adjustable from an open configuration to a closed configuration.

19. The charger of claim 18, wherein the support member defines a cavity to house the power source.

20. The charger of claim 19, wherein the support member further comprises a wire management system.
